(19) United States
(12) Patent Application Publication
(10) Pub. No.: US 2026/0249659 A1
(43) Pub. Date: Aug. 27, 2026

(54) AUTOMOTIVE SHOCK ABSORBER ASSEMBLY

(71) Applicant: FLEXIS, BOULOGNE-BILLANCOURT (FR)

(72) Inventor: Christian DELORD, VILLIERS-SAINT-FREDERIC (FR)

(21) Appl. No.: 19/549,336

(22) Filed: Feb. 25, 2026

(30) Foreign Application Priority Data
Feb. 27, 2025 (FR) FR2501996

(51) Int. Cl. B60G 15/06

(52) U.S. Cl. CPC B60G 15/068; B60G 2202/312; B60G 2204/128

(57) ABSTRACT

An assembly for an automotive shock absorber, including: a filter block, including a triangular external edge; a shock absorber cup, including a first peripheral portion and a first central portion; fitted around the external edge of the filter block; and an upper reinforcement, including a second peripheral portion and a second central portion. In an assembled configuration: the cup is arranged between the filter block and the upper reinforcement; the first and second peripheral portions are in contact with one another; and the first and second central portions are in contact with one another; each of the first and second central portions includes a fastening zone.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to an assembly for an automotive shock absorber, of the type including: a filter block, comprising a substantially planar body, said body comprising an external edge forming substantially an equilateral triangle; a shock absorber cup, comprising a cup base; said base comprising a first peripheral portion and a first central portion, continuous relative to one another; said first peripheral and central portions being substantially planar, substantially parallel to one another, and separated by a non-zero first distance; the first central portion being able to fit around the external edge of the body of the filter block; and an upper reinforcement, comprising a second peripheral portion and a second central portion, continuous relative to one another; said second peripheral and central portions being substantially planar, substantially parallel to one another, and separated by a non-zero second distance.

Such a shock absorber assembly is subjected to significant structural stresses and requires careful development, depending in particular on the level of suspension forces experienced by the vehicle.

### BACKGROUND

In particular, existing solutions that give good results for high force levels have high weight and cost, which degrades their performance in the context of lower force levels.

### SUMMARY

The present disclosure aims to propose a shock absorber assembly leading to optimal transmission of force to the vehicle structure.

To this end, the subject of the present disclosure is an assembly of the aforementioned type, configured such that in an assembled configuration: the filter block, the cup, and the upper reinforcement are fixed to one another, each of said filter block, said cup, and said upper reinforcement being arranged around the same main axis; the cup is arranged between the filter block and the upper reinforcement along the main axis; the first and second peripheral portions are in contact with one another; and the first and second central portions are in contact with one another; each of the first and second central portions including: a main zone, forming substantially an equilateral triangle and comprising a first, a second, and a third vertex; and a fastening zone, arranged substantially at equal distance from the first and second vertices and forming a protrusion relative to the main zone opposite the third vertex.

According to other advantageous aspects of the present disclosure, the assembly includes one or more of the following features, taken alone or in any technically possible combinations:

the upper reinforcement further comprises an arm, extending perpendicularly to the main axis from the second peripheral portion; the assembly further comprising a crossmember reinforcement, in contact with said arm of the upper reinforcement, said crossmember reinforcement comprising a fastening surface, fastened to the fastening zone of the second central portion of said upper reinforcement;

the filter block comprises a central orifice, centered on the main axis; and the assembly further comprises a shock absorber strut, said strut comprising a rod extending along the main axis and assembled to the central orifice of said filter block;

the assembly further comprises at least one fastener passing through the filter block, the cup, and the upper reinforcement;

in the assembled configuration, the body of the filter block, and the first central portion of the base of the cup are in contact with one another;

the assembly further comprises a spacer set, arranged between the body of the filter block and the base of the cup, said spacer set being in contact with each of the first peripheral and central portions of said base;

the spacer set comprises first and second support elements; the first support element comprising a contact surface able to match the first peripheral portion of the cup base; the second support element comprising a substantially triangular outline, able to fit into the first central portion of the cup base, said second support element being sandwiched between the first support element and said first central portion along the main axis;

the at least one fastener further passes through the first and second support elements.

The present disclosure further relates to a vehicle comprising: a chassis; at least one wheel; and at least one shock absorber assembly as described above, said assembly being connected to said chassis and to said wheel.

According to an advantageous aspect of the present disclosure, the chassis comprises a crossmember; and the arm of the upper reinforcement and the crossmember reinforcement are fastened to said crossmember.

### BRIEF DESCRIPTIONOF THE DRAWINGS

The present disclosure will appear more clearly upon reading the following description, given solely by way of non-limiting example, and made with reference to the drawings wherein:

FIG. 1 shows a shock absorber assembly according to a first embodiment of the present disclosure;

FIG. 2 is a partial exploded view of the assembly shown in FIG. 1;

FIG. 3 is a sectional view of the assembly shown in FIG. 1;

FIG. 4 is a partial exploded view of a shock absorber assembly according to a second embodiment of the present disclosure; and

FIG. 5 is a sectional view of the assembly shown in FIG. 4.

### DETAILED DESCRIPTION

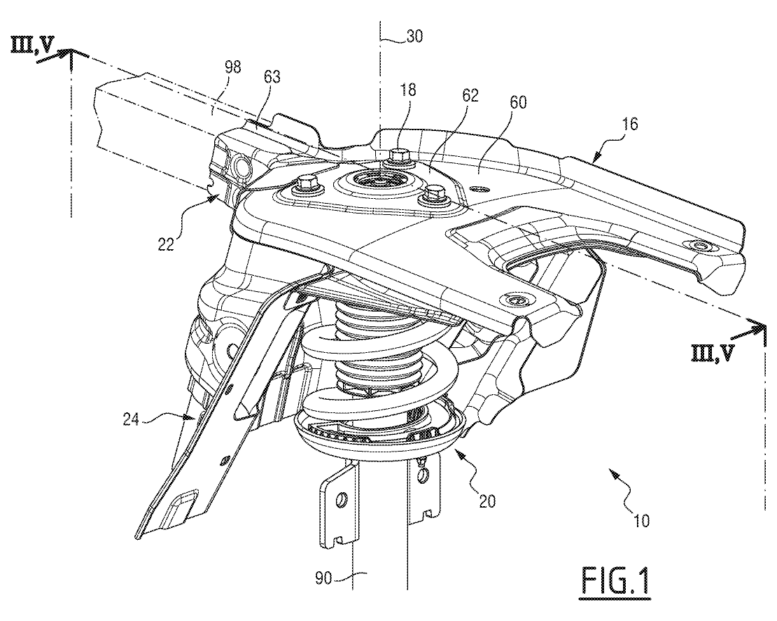

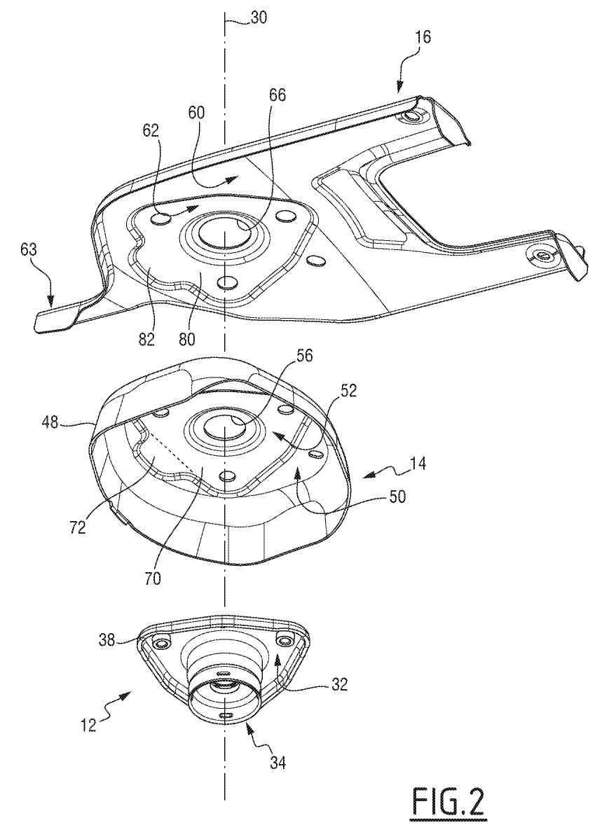

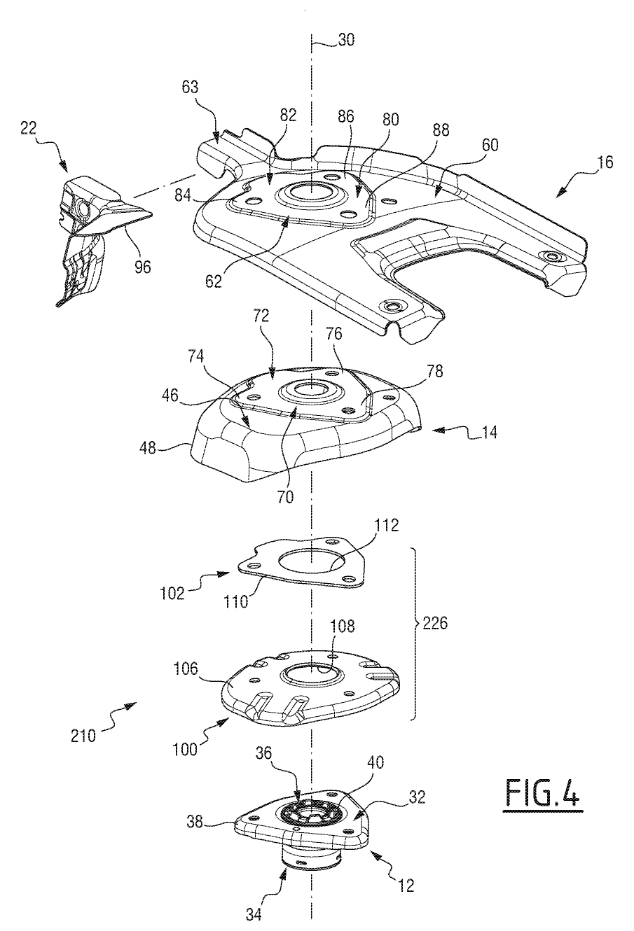

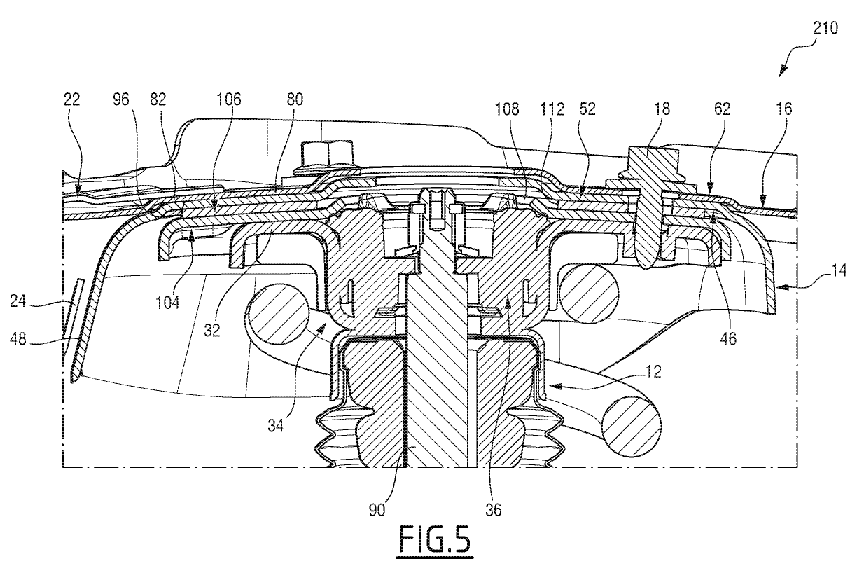

FIGS. 1 to 3 show a shock absorber assembly 10, according to a first embodiment of the present disclosure. FIGS. 4 and 5 show an assembly 210 according to a second embodiment of the present disclosure. The assemblies 10 and 210 comprise common elements.

In known manner, each of the assemblies 10 and 210 is intended to be assembled, on the one hand to a body (not shown), on the other hand to a wheel (not shown) of a land vehicle, in particular an automotive vehicle. In particular, each of the assemblies 10 and 210 is intended to ensure transmission of suspension forces from the wheels to the body of said vehicle.

The assemblies 10 and 210 will be described simultaneously hereafter, the common elements being designated by the same reference numbers.

The assembly 10, 210 comprises: a filter block 12; a shock absorber cup 14; and an upper reinforcement 16. In the illustrated embodiments, the assembly further comprises: at least one fastener 18; a shock absorber strut 20; a crossmember reinforcement 22; and a cup riser 24.

In the embodiment shown in FIGS. 4 and 5, assembly 210 further comprises an intermediate set 226.

In an assembled configuration, visible in FIGS. 1, 3, and 5, assembly 10, 210 extends along a main axis 30. In an operating position of assembly 10, 210, main axis 30 is substantially vertical. In the description that follows, the terms "upper", "lower", "top", "bottom", etc., refer to the operating position of assembly 10, 210.

The filter block 12 comprises an upper body 32, a lower body 34, and a damping member 36.

The upper body 32 is substantially planar and substantially perpendicular to the main axis 30. The upper body 32 comprises an external edge 38 forming substantially an equilateral triangle and centered on the main axis 30.

Furthermore, the upper body 32 comprises a central orifice 40, centered on main axis 30 and having a substantially circular outline.

The lower body 34 is tubular and extends along the main axis 30, between an upper end and a lower end. The upper end of said lower body 34 is integral with the upper body 32 and surrounds the central orifice 40.

The lower body 34 includes an intermediate partition 42, substantially perpendicular to the main axis 30. The intermediate partition 42 comprises an intermediate orifice 44, centered on the main axis and having a diameter smaller than the central orifice 40 of the upper body 32.

The damping member 36 is housed in the lower body 34, above the intermediate partition 42. The central orifice 40 of the upper body 32 opens onto said damping member 36.

The cup 14 comprises a base 46 and an edge 48. The base 46 is substantially planar and substantially perpendicular to the main axis 30. The edge 48 extends downward from a periphery of the base 46.

More specifically, the base 46 of the cup 14 comprises a first peripheral portion 50 and a first central portion 52, continuous relative to one another. The first peripheral portion 50 is arranged around the first central portion 52.

Said first peripheral 50 and central 52 portions are substantially planar, substantially parallel to one another, and separated by a non-zero first distance 54. Said first peripheral 50 and central 52 portions are substantially perpendicular to the main axis 30 and arranged around said main axis.

As specified below, the first central portion 52 is able to fit around the external edge 38 of the upper body 32 of the filter block 12.

Preferably, the base 46 of the cup 14 is formed from sheet metal comprising a stamping that defines the first peripheral 50 and central 52 portions.

In the illustrated embodiment, the base 46 of the cup 14 further comprises a first central opening 56, centered on the main axis 30 and formed in the first central portion 52.

The upper reinforcement 16 comprises a second peripheral portion 60 and a second central portion 62, continuous relative to one another. In the illustrated embodiment, the upper reinforcement 16 further comprises an arm 63.

The second peripheral portion 60 is arranged around the second central portion 62. The second peripheral 60 and central 62 portions are substantially planar, substantially parallel to one another, and separated by a non-zero second distance 64, substantially equal to the first distance 54. Preferably, the upper reinforcement 16 is formed from sheet metal comprising a stamping that defines the second peripheral 60 and central 62 portions.

The second peripheral 60 and central 62 portions are substantially perpendicular to the main axis 30 and arranged around said main axis.

As specified below, the second central portion 62 has a shape analogous to that of the first central portion 52 of the base 46 of the cup 14, said second central portion 62 being able to fit onto said first central portion 52.

The arm 63 extends in a substantially straight manner from the second peripheral portion 60, substantially perpendicularly to the main axis 30.

In the illustrated embodiment, the upper reinforcement 16 further comprises a second central opening 66, centered on the main axis 30 and formed in the second central portion 62.

The first central portion 52 of the base 46 of the cup 14 will now be described more precisely.

The first central portion 52 comprises a first main zone 70 and a first fastening zone 72.

The first main zone 70 forms substantially an equilateral triangle and comprises a first 74, a second 76, and a third 78 vertex. The first fastening zone 72 has the shape of a tab, arranged substantially at equal distance from first 74 and second 76 vertices and forming a protrusion relative to the first main zone 70, opposite the third vertex 78.

The second central portion 62 of the upper reinforcement 16 will now be described more precisely.

The second central portion 62 comprises a second main zone 80 and a second fastening zone 82.

The second main zone 80 forms substantially an equilateral triangle and comprises a fourth 84, a fifth 86, and a sixth 88 vertex. The second fastening zone 82 has the shape of a tab, arranged substantially at equal distance from fourth 84 and fifth 86 vertices and forming a protrusion relative to the second main zone 80, opposite the sixth vertex 88.

The second fastening zone 82 of the second central portion 62 is arranged substantially facing arm 63 of the upper reinforcement 16. More precisely, the second fastening zone 82 is arranged substantially between said arm 63 and the second main zone 80 of the second central portion 62.

In the assembled configuration shown in FIGS. 1, 3, and 5, the filter block 12, cup 14, and upper reinforcement 16 are fastened to one another. For example, the at least one fastener 18 is of the screw type and passes through the filter block 12, cup 14, and upper reinforcement 16. In the illustrated embodiments, the assembly 10, 210 includes three fasteners 18, distributed around the main axis 30. Said fasteners 18 pass through the upper body 32 of the filter block 12 and the first 52 and second 62 central parts of the base 46 of the cup and of the upper reinforcement 16.

Furthermore, in the assembled configuration, the cup 14 is arranged between the filter block 12 and the upper reinforcement 16 along the main axis 30. The first 56 and second 66 central openings of the cup 14 and of the upper reinforcement 16 open onto the central orifice 40 of the upper body 32 of the filter block 12.

In particular, in the assembled configuration, the first central part 52 of the base 46 of the cup is fitted onto the upper body 32 of the filter block 12. More precisely, in the assembled configuration, an outline of the first main zone 70 of the first central part 52 faces the triangular external edge 38 of the upper body 32.

The fitting of the first central part 52 of the base 46 of the cup onto the upper body 32 of the filter block 12 will be described in more detail below, for each of the assemblies 10 and 210.

Moreover, in the assembled configuration, the second central part 62 of the upper reinforcement 16 is fitted onto the first central part 52 of the base 46 of the cup. More precisely, in the assembled configuration, the first 50 and second 60 peripheral portions are in contact with one another; and the first 52 and second 62 central portions are in contact with one another. Even more precisely, the first 70 and second 80 main zones of said central portions are in contact with one another and the first 72 and second 82 fastening zones of said central portions are in contact with one another.

The shock absorber strut 20 comprises in particular a rod 90, extending along the main axis 30 between an upper end 92 and a lower end. The upper end 92 of rod 90 is assembled to the filter block 12. More precisely, said upper end 92 passes through the intermediate orifice 44 of the intermediate partition 42 of the lower body 34 and is fastened to the damping member 36, for example, by means of a nut 94 with washer.

The crossmember reinforcement 22 is assembled to the arm 63 of the upper reinforcement 16 and to the second peripheral portion 60 of said upper reinforcement, near the arm 63.

The crossmember reinforcement 22 comprises a fastening surface 96, substantially planar and tab-shaped. In the assembled configuration, said fastening surface 96 is fastened to the second fastening zone 82 of the second central portion 62 of the upper reinforcement 16. Preferably, said fastening surface 96 and said second fastening zone 82 are fastened to one another by weld spots.

The arm 63 of the upper reinforcement 16 is in particular intended to be fastened to a crossmember 98, shown in dotted lines in FIG. 1. The crossmember 98 is part of the body (not shown) of the vehicle incorporating the assembly 10, 210.

The crossmember reinforcement 22 is also intended to be fastened to the crossmember 98. The weld spots between the fastening surface 96 of the crossmember reinforcement 22 and the second fastening zone 82 of the upper reinforcement 16 allow better transmission of forces from the strut 20 to the vehicle body. The resistance of the assembly 10, 210 to operating forces is thus improved.

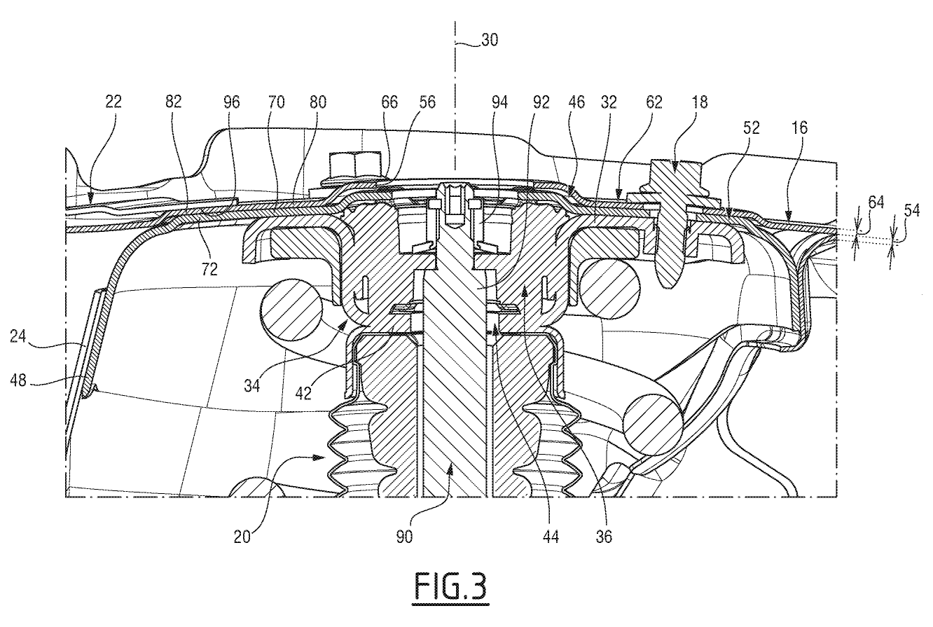

The cup riser 24 is assembled to the edge 48 of the cup 14, as visible in FIGS. 3 and 5.

The differences between the assemblies 10 and 210 described above will now be described more precisely, concerning the fitting of the first central part 52 of the base 46 of the cup onto the upper body 32 of the filter block 12.

In the assembled configuration of the assembly 10, the first central part 52 of the base 46 of the cup is in contact with the upper body 32 of the filter block 12, as visible in FIG. 3. Such an assembly 10 is suitable for an automotive vehicle of moderate weight and/or exposed to moderate suspension forces.

In the assembly 210, the spacer set 226 is arranged between the upper body 32 of the filter block 12 and the base 46 of the cup 14. More precisely, the spacer set 226 is sandwiched between said upper body 32 of the filter block and said base 46 of the cup.

In particular, said spacer set 226 is in contact with each of the first peripheral 50 and central 52 portions of the base 46 of the cup 14, for optimal transmission of forces. Such an assembly 210 is in particular suitable for an automotive vehicle of high weight and/or exposed to high suspension forces.

In the illustrated embodiment, the spacer set comprises first 100 and second 102 support elements, removable relative to one another.

The first support element 100 is substantially planar and perpendicular to the main axis 30. In the illustrated embodiment, the first support element 100 comprises in particular: a lower surface 104; an upper surface 106; and a third central opening 108, centered on the main axis 30.

In the assembled configuration visible in FIG. 5, the lower 104 and upper 106 surfaces of the first support element 100 are in contact, respectively, with the upper body 32 of the filter block 12 and with the first peripheral portion 50 of the base 46 of the cup 14.

The second support element 102 is substantially planar and perpendicular to the main axis 30. The second support element 102 comprises an outline 110 that is substantially triangular, able to fit into the first central portion 52 of the base 46 of the cup. In particular, a thickness of the second support element 102 is substantially equal to the first distance 54 between the first peripheral 50 and central 52 portions of said base 46.

Preferably, as in the illustrated embodiment, the outline 110 of the second support element 102 is configured to fit both into the first main zone 70 and into the first fastening zone 72 of the first central portion 52 of the base 46 of the cup.

The second support element 102 further comprises a fourth central opening 112, centered on the main axis 30.

In the assembled configuration visible in FIG. 5, the second support element 102 is in contact with the upper surface 106 of the first support element 100 and is sandwiched between said first support element 100 and the first central portion 52 along the main axis 30.

Moreover, in said assembled configuration, the third 108 and fourth 112 central openings open onto the central orifice 40 of the upper body 32 of the filter block 12.

Moreover, in said assembled configuration, the fasteners 18 also pass through the first 100 and second 102 support elements.

Preferably, in the illustrated embodiment, the second support element 102 is further fastened to the cup 14 and/or to the first support element 100 by weld spots.

Thus, with the exception of the spacer set 226, the assemblies 10 and 210 are formed of identical elements. The assembly 10, 210 described above can therefore be easily adapted to the corresponding vehicle model, depending on whether it is a vehicle associated with moderate or high suspension forces.

The assembly 10, 210 is therefore resistant to operating forces, versatile, and easily optimizable in terms of weight and cost, depending on the vehicle into which it is integrated.

What is claimed is:

1. An assembly for an automotive shock absorber comprising:
a filter block comprising a substantially planar body, said substantially planar body comprising an external edge forming substantially an equilateral triangle;
a shock absorber cup comprising a cup base; the cup base comprising a first peripheral portion and a first central portion, continuous relative to one another; the first peripheral portion and the first central portion being substantially planar, substantially parallel to one another, and separated by a non-zero first distance; the first central portion being able to fit around the external edge of the body of the filter block; and
an upper reinforcement comprising a second peripheral portion and a second central portion, continuous relative to one another; the second peripheral portion and the second central portion being substantially planar, substantially parallel to one another, and separated by a non-zero second distance,
wherein the assembly is configured such that in an assembled configuration:
the filter block, the shock absorber cup, and the upper reinforcement are fastened to one another, each of said filter block, said shock absorber cup, and said upper reinforcement being arranged around the same main axis; the shock absorber cup is arranged between the filter block and the upper reinforcement along the main axis;
the first and second peripheral portions are in contact with one another; and
the first and second central portions are in contact with one another, and
wherein each of the first and second central portions comprise:
a main zone forming substantially an equilateral triangle and comprising a first vertex, a second vertex, and a third vertex; and
a fastening zone arranged substantially at equal distance from the first and second vertices and forming a protrusion relative to the main zone opposite the third vertex.

2. The assembly according to claim 1, wherein the upper reinforcement further comprises an arm extending perpendicularly to the main axis from the second peripheral portion; the assembly further comprising a crossmember reinforcement in contact with said arm of the upper reinforcement, said crossmember reinforcement comprising a fastening surface fastened to the fastening zone of the second central portion of said upper reinforcement.

3. The assembly according to claim 1, wherein the filter block comprises a central orifice centered on the main axis; the assembly further comprises a shock absorber strut, said shock absorber strut comprising a rod extending along the main axis and assembled to the central orifice of said filter block.

4. The assembly according to claim 1, further comprising at least one fastener passing through the filter block, the shock absorber cup, and the upper reinforcement.

5. The assembly according to claim 1, wherein, in the assembled configuration, the substantially planar body of the filter block and the first central portion of the cup base of the shock absorber cup are in contact with one another.

6. The assembly according to claim 1, further comprising a spacer set arranged between the substantially planar body of the filter block and the cup base of the shock absorber cup, said spacer set being in contact with each of the first peripheral portion and the first central portion of said cup base.

7. The assembly according to claim 6, wherein the spacer set comprises first and second support elements; the first support element comprising a contact surface configured to match the first peripheral portion of the cup base; the second support element comprising a substantially triangular outline configured to fit into the first central portion of the cup base, said second support element being sandwiched between the first support element and said first central portion along the main axis.

8. The assembly according to claim 7, further comprising at least one fastener passing through the filter block, the shock absorber cup, the upper reinforcement, and the first and second support elements.

9. A vehicle comprising: a chassis; at least one wheel; and at least one shock absorber assembly according to claim 1, said assembly being connected to said chassis and to said at least one wheel.

10. The vehicle according to claim 9, wherein the chassis comprises a crossmember, wherein the upper reinforcement further comprises an arm extending perpendicularly to the main axis from the second peripheral portion, the assembly further comprising a crossmember reinforcement in contact with said arm of the upper reinforcement, said crossmember reinforcement comprising a fastening surface fastened to the fastening zone of the second central portion of said upper reinforcement , and wherein the arm of the upper reinforcement and the crossmember reinforcement are fastened to said crossmember.
